(19) United States
(12) Patent Application Publication
(10) Pub. No.: US 2019/0184403 A1
(43) Pub. Date: Jun. 20, 2019

(54) ROTATABLE FEED DISTRIBUTOR

(71) Applicant: SANDVIK INTELLECTUAL PROPERTY AB, Sandviken (SE)

(72) Inventors: Michael ONESTI, Oxie (SE); Henrik JOHANSSON, Malmo (SE); Michael SKOG, Lund (SE)

(73) Assignee: Sandvik Intellectual Property AB, Sandviken (SE)

(21) Appl. No.: 16/309,540

(22) PCT Filed: Jun. 14, 2016
(86) PCT No.: PCT/EP2016/063581

§ 371 Date: Dec. 13, 2018

(51) Int. Cl. B02C 2/00; B02C 23/02

(52) U.S. Cl. CPC B02C 2/007; B02C 23/02

(57) ABSTRACT

A feed distributor includes a rotatable chute mounted and suspended within a housing. Respective drive components for the rotatable chute are mounted within a working part zone defined by the housing. Such drive components are protected from dust and particulate contamination by a plurality of seal rings and/or an air feed assembly configured to create a positive pressure within the working part zone and a corresponding exhaust air flow at specific regions of the housing.

### FIELD OF INVENTION

The present invention relates to a rotatable feed distributor for a crusher, and in particular although not exclusively, to a feed distributor for a gyratory crusher configured to manipulate a feeding supply of crushable material into an inlet region of the crusher.

### BACKGROUND ART

Generally, a belt conveyor or feeder delivers rocks and stones into a crusher. The rocks ride up the conveyor, whose end is located above the input of the crusher and then fall under gravity into the crusher where they are broken to a predetermined size. Typically, the uncrushed rocks pass initially through a feed distributor, which assists in dispensing the rocks into the crusher.

Since rocks fed into the crusher are not always of the same size and shape, they will not necessarily be reduced to a final desired and uniform size. However, it is preferable to obtain the crushed rocks within a relative size range, otherwise the material may require further processing. Furthermore, the final crushed rock product should preferably have a uniform size and shape gradation, rather than having a batch of stones that may contain very fine dust as a product and another batch that only contains larger rocks. Such rock segregation is disadvantageous as it can lead to a less saleable end product.

A variety of different feed distributors have been proposed with examples described in U.S. Pat. No. 7,040,562; U.S. Pat. No. 6,227,472; U.S. Pat. No. 4,106,707; and U.S. Pat. No. 3,212,720. However premature wear of specific parts of existing feed distributors is a continuous problem. In particular, when rocks fall upon the distributor and in particular a distributor chute, the impact tends to wear and erode specific components. Additionally, the rock crushing environment creates excess and abrasive dust which can also cause premature wear of certain machine elements, such as bearings. As a result feed distributor components require regular replacement and maintenance, which increases downtime of the crushing system and consequently reduces the efficiency of the overall system.

U.S. Pat. No. 7,040,562 and U.S. Pat. No. 8,056,847 describe rotating feed distributors that provide improved resistance to the impacting forces and abrasive dust resulting from the transfer of the crushable material. However, the problems of excessive wear due to dust and particulate contamination within the internal region of the distributor remains problematic. Accordingly, there is a need for a feed distributor that addresses these problems.

### SUMMARY OF THE INVENTION

It is an objective of the present invention to provide a feed distributor for a crusher and in particular a gyratory crusher that is effective to distribute and dispense a flow of crushable material into a crusher so as to optimise the distribution of material fed into the crushing zone whilst providing a distributor that is effectively robust against the dust and debris laden environment within which the distributor is typically operative. It is a further specific objective to provide a distributor that requires reduced maintenance and is configured to protect internal component, in particular moving parts and surfaces, so as to extend the longevity of the distributor working parts and in turn minimise system downtime.

The objectives are achieved by providing a feed distributor having a rotatable chute operating and mounted at a housing such that dust, debris or other particulate matter is prevented from being entrained into the housing (from the region of the chute) that would otherwise contaminate the internal working part zone within the housing and within which the various drive and bearing components are located to drive and stabilise the rotating motion of the chute.

In particular, and according to one aspect, a feed distributor is provided comprising at least one seal ring or a plurality of seal rings located at one or a plurality of regions between the chute and parts of the housing. The seal rings provide an effective physical barrier to the ingress of particulates at specific locations between the chute and housing. According to further aspects, a feed distributor is provided that is capable of creating a positive pressure within the working part zone (defined by the housing) such that dust and debris ingress into the working part zone is inhibited or preferably prevented by an exhaust air flow stream flowing from the region of the working part zone to exhaust from between selected regions of the rotatable chute and housing. In certain aspects, a distributor is provided with a combination of at least one sealing ring and an air feed assembly (communicating with and providing the positive pressure at the working part zone) such that dust and debris ingress into the working part zone is prevented by a combination of such seals and the positive pressure (air flow and exhaust).

Preferably, the present feed distributor is intended to sit beneath the top end or output end of a conveyor or feeder used in conjunction with a rock crusher. The conveyor or feeder is capable of delivering rocks from a supply source to the distributor that is positioned over the crusher. The present feed distributor is configured to receive the rocks onto a feed platform, where the rocks travel from the feed platform into a feed chute comprising an inlet and an outlet. Optionally, the feed chute may have an outer tube and an inner tube, with the outer tube configured to rotate and the inner tube being relatively stationary. The outer tube may be driven by a motor coupled to a gear mechanism. The use of two tubes reduces the wear on the feed distributor as the rotating outer tube allows the rocks to be evenly distributed into the crusher which in turn minimises rock size segregation, which improves the crusher efficiency and reduces operating costs.

The present feed distributor provides for an even distribution of the rocks before entering the crusher, thereby minimizing uneven rock build-up within the crusher and further minimizing the need for recycling or re-crushing of rocks that are not crushed within predetermined size limitations. The present feed distributor is configured specifically via the at least one seal ring and/or positive pressure within the working part zone to protect a power means, a support means and drive system (encompassing bearings, bearing surfaces, drive belts, belt surfaces, pulleys, gears and other working components and surfaces) from abrasive dust and other rock particles, thereby reducing the overall wear on the feed distributor. The arrangement of the seal ring and/or positive air pressure protected working part zone provides for a reliable and low maintenance drive and chute support system.

Optionally, the feed distributor comprises a sheave coupled around the rotating outer tube (chute). The sheave may comprise a flange and a face, the flange and face being perpendicular to one another. The sheave structure may be supported on its flange by a plurality of thrust bearings mounted to the feed distributor housing. Accordingly the rotating outer tube is preferably supported by the thrust bearings. The sheave is configured to receive one or more drive belts driven by a power means, such as a motor and gear reducer assembly. A distance between the power means and rotating outer tube may be maintained by a plurality of roller bearings circumferentially arranged about the sheave.

According to a first aspect of the present invention there is provided a rotating feed distributor for a crusher comprising: a housing defining an internal working part zone; a rotatable chute to receive crushable material to be fed to a crusher, the chute defining at least part of an internal bore provided with an inlet and an outlet; a sheave provided externally at and rotatably coupled with the chute; a power means and drive transmission mounted within the working part zone, at least part of the drive transmission coupled to the sheave to provide rotation of the chute relative to the housing; characterised by: at least one seal ring provided at the chute to at least partially close a gap region between the chute and a part of the housing and inhibit ingress of dust into the working part zone.

Preferably, the housing comprises an inlet aperture and an outlet aperture in fluid communication with the working part zone to allow the crushable material to pass through the housing and into the internal bore, the chute projecting trough at least the outlet aperture and at least partially into the working part zone.

Preferably, at least a first seal ring is provided between the inlet of the chute and a part of the housing that defines the inlet aperture. Optionally, the first seal ring is positioned within the working part zone and is positioned against an internal facing surface of the housing that defines the working part zone. Optionally, at least a second seal ring is provided between the chute and a part of the housing that defines the outlet aperture. Optionally, the second seal ring is positioned externally to the working part zone and against an external facing surface of the housing relative to the working part zone. The seal rings may be positioned directly or indirectly (via an intermediate gasket) against the housing.

Within this specification reference to the chute and housing having a respective inlet and outlet is with regard to a flow of crushable material through the distributor as the distributor supplies material to the crusher.

Preferably, a first seal ring is provided at a first region of the chute to provide at least partial closure of a first gap region between the first region of the chute and a first part of the housing that is internal facing relative to the working part zone. Preferably, a second seal ring provided at a second region of the chute to provide at least partial closure of a second gap region between the second region of the chute and a second part of the housing that is external facing relative to the working part zone.

Preferably, the first seal ring is positioned at or towards the inlet of the chute and the second seal ring is spatially separated from the first seal ring and is positioned between the first seal ring and the outlet of the chute.

Preferably, the at least one seal ring comprises an annular main body and a flexible annular flange projecting from the main body. Preferably, the at least one seal ring comprise a V-ring seal.

Preferably, the distributor comprises at least one clamp to radially compress against the at least one seal ring and secure the seal ring at an external facing surface of the chute such that the seal ring is rotatably coupled to the chute.

Optionally, the chute comprises a radially outward projecting shoulder to abut the seal ring or comprises a radially inward projecting groove at an outward facing surface of the chute to at least partially receive the seal ring. The groove or shoulder is configured to assist the clamp (secured around the seal ring), maintain the desired position of the seal ring at the outward facing surface of the chute. Where the chute comprises a shoulder to help seat the seal ring, the shoulder does not project radially outward from the outward facing surface to an extent that would other inhibit or prevent the seal ring from being axially slid over the outward facing surface from the chute outlet towards the chute inlet.

Preferably, the distributor comprises an air feed assembly coupled in fluid communication with the working part zone to provide a supply of air into the working part zone. Preferably, the air feed assembly comprises ducting and any one of a fan, a compressor or pneumatic system to generate an air flow stream through the ducting and into the working part zone.

According to a second aspect of the present invention there is provided a rotating feed distributor for a crusher comprising: a housing defining an internal working part zone; a rotatable chute to receive crushable material to be fed to a crusher, the chute defining at least part of an internal bore provide with an inlet and an outlet; a sheave provided externally at and rotatably coupled with the chute; a power means and drive transmission mounted within the working part zone, at least part of the drive transmission coupled to the sheave to provide rotation of the chute relative to the housing; characterised by: an air feed assembly coupled in fluid communication with the working part zone to provide a supply of air into the working part zone, the air capable of exhausting from the working part zone from at least a region between the chute and the housing to inhibit ingress of dust into the working part zone.

According to a third aspect of the present invention there is a provided a gyratory crusher comprising a feed distributor as described and claimed herein.

### BRIEF DESCRIPTION OF DRAWINGS

A specific implementation of the present invention will now be described, by way of example only, and with reference to the accompanying drawings in which:

FIG. 1 is a side view of the present invention in combination with a rock crusher and a feed conveyor;

FIG. 2 is a perspective view of the present invention;

FIG. 3 is a bottom plan view of the present invention;

FIG. 4 is a sectional side view of the present invention taken along line 4-4 of FIG. 3;

FIG. 5 is a partial cut away sectional side view;

FIG. 6 is another partial cut away section side view;

FIGS. 7 and 8 are sectional side views of the present invention, feedbox and rocks;

FIG. 9 is overhead view of a crusher used in connection with the present invention;

FIG. 10 is a cross sectional perspective view through the chute section of the distributor;

FIG. 11 is an underside cross sectional perspective view of the distributor of FIG. 10;

FIG. 12 is a cross sectional perspective view of a first seal ring mounted between the chute and housing of FIG. 11;

FIG. 13 is a cross sectional perspective view of a second seal ring mounted between the chute and housing of the distributor of FIG. 11;

FIG. 14 is a further cross sectional perspective view of the feed distributor.

### DETAILED DESCRIPTION OF PREFERRED EMBODIMENT OF THE INVENTION

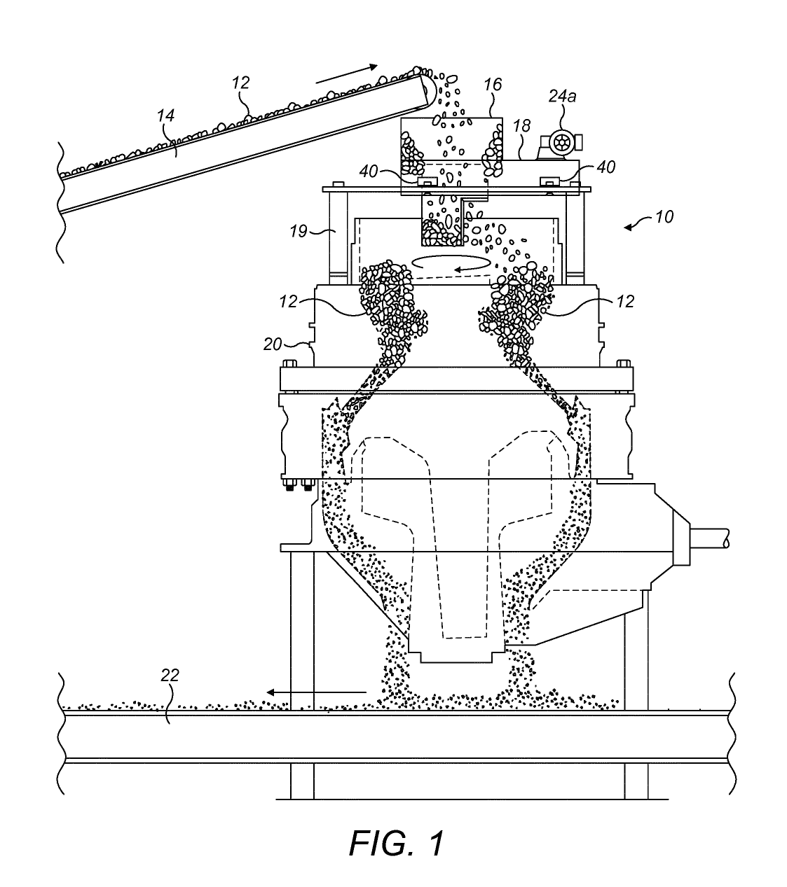

FIG. 1 shows a side view of a rock crushing system 10 employing the present invention. A plurality of rocks 12 is fed upwards on a conveyor 14. The conveyor 14 delivers the rocks 12 through a feedbox 16 and into an improved feed distributor 18, which is the focus of the present invention. The feed distributor 18 is designed for 360 degree rotation and delivers the rocks 12 uniformly to the crusher 20. The distributor 18 may be mounted to the crusher 20, the conveyor 14, or may be mounted independently. A frame or mount 19 holds the feed distributor 18 in place over the crusher 20. The frame 19 can encompass a wide range of shapes and sizes that will adequately mount the distributor 18 over the crusher 20. The feedbox 16 should be considered a stand-alone feature that is not part of the present invention. The feed distributor 18 passes the rocks 12 into the crusher 20, which rotates or gyrates and crushes the rocks 12. The crushed rocks 12 exit below the crusher 20, possibly onto a second conveyor 22, which will then take the crushed rocks 12 away to be used, further sorted, or to be recycled and reprocessed in the rock crushing system 10.

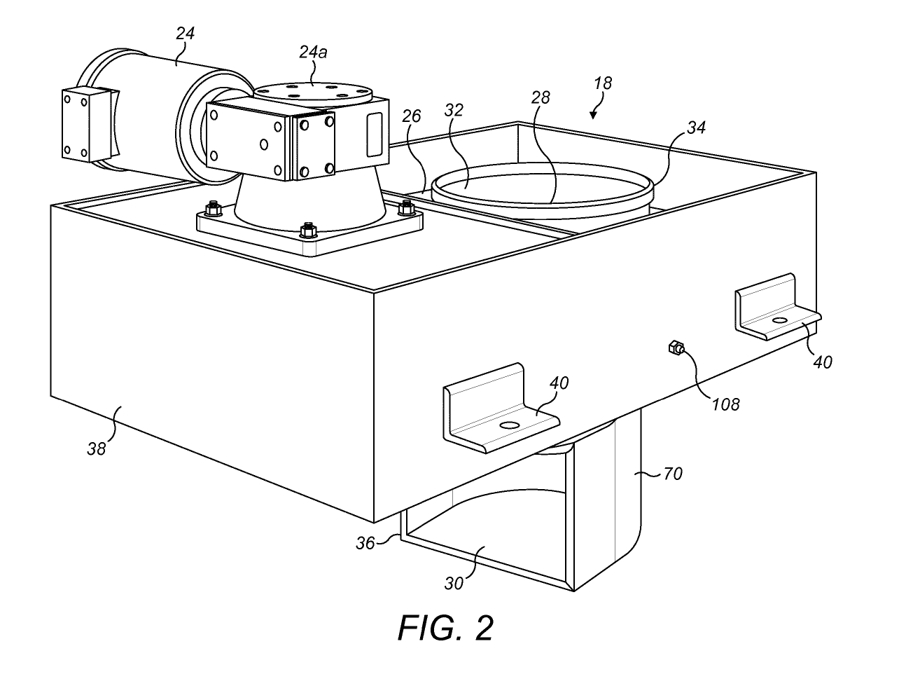

FIG. 2 shows a perspective view of the improved feed distributor 18. A power means, such as electric motor 24 of any sufficient design or size that will adequately allow the distributor 18 to operate powers the feed distributor 18. The output of the motor 24 is rotationally coupled to a gear reducer 241a, which in turn drives the rotating components of the feed distributor 18.

The feed distributor 18 has three main areas that the rocks will encounter when proceeding towards the crusher 20: a feed platform or box 26, an inlet 28, and an outlet 30. The inlet 28 and the outlet 30 generally are opposing sections of a tubular chute 32 containing a coextensive bore within the chute 32, which will be described in more detail with respect to the subsequent figures. When rocks 12 enter into the distributor 18, as shown in FIG. 1, the rocks 12 fill up the feed platform 26 and some of them drop into the inlet 28. After enough rocks have accumulated on the platform 26, all of the rocks 12 will pass into the inlet 28, further traveling through to the outlet 30, where they will eventually end up in the crusher 20. The inlet 28 includes a reinforced lip 34, which helps to extend the life of the inlet 28. Similarly, a second lip 36 is located around the outlet 30 to also extend the life of the outlet 30 (see FIG. 2). The lips 34 and 36 may be designed in any fashion, such as from a metal rod or similar material that may be welded to the inlet 28 and the outlet 30, which will reduce wear on the inlet 28 and outlet 30.

Again referring to FIG. 2, the feed distributor 18 comprises a housing 38, which prevents dust and other debris from interfering with mechanical components of the feed distributor 18. The housing 38 may be of any shape that will efficiently protect the internal components and not interfere with the functions of the distributor 18. Preferably, the housing 38 is designed so that it substantially seals off the inner parts of the distributor 18 from the outside elements. A plurality of brackets 40 is provided on the outside of the housing 38. The brackets 40 provide an area for the distributor 18 to be mounted onto the frame 19 over the crusher 20 (see FIG. 1). The brackets 40 should be understood to encompass any mounting means that will sufficiently secure the distributor 18 to the crusher 20. Similarly, the brackets 40 together with the frame 19 may be of any design. For instance, the distributor 18 does not necessarily need to be firmly bolted down, but may be held in place with stop blocks (not shown).

The inlet 28 and the outlet 30 comprise the tubular chute 32. Located within the inlet 28 is an optional stationary tube or wear sleeve 62. The stationary tube or wear sleeve 62 preferably extends a distance above the inlet 28 and also a distance below the inlet 28. The reinforced lip 34 formed along the upper edge of the wear sleeve 62 helps to extend the life of the inlet 28. When the wear sleeve 62 is employed in the feed distributor 18, the previously described lip 34 is located at the top of the wear sleeve 62. While the wear sleeve 62 may be secured to the inlet 28, it preferably rests upon the feed platform 26. A laterally extending flange 64 assists in the wear sleeve 62 resting on the feed platform 26. When it becomes worn down, the wear sleeve 62 may be easily removed and replaced with a new sleeve.

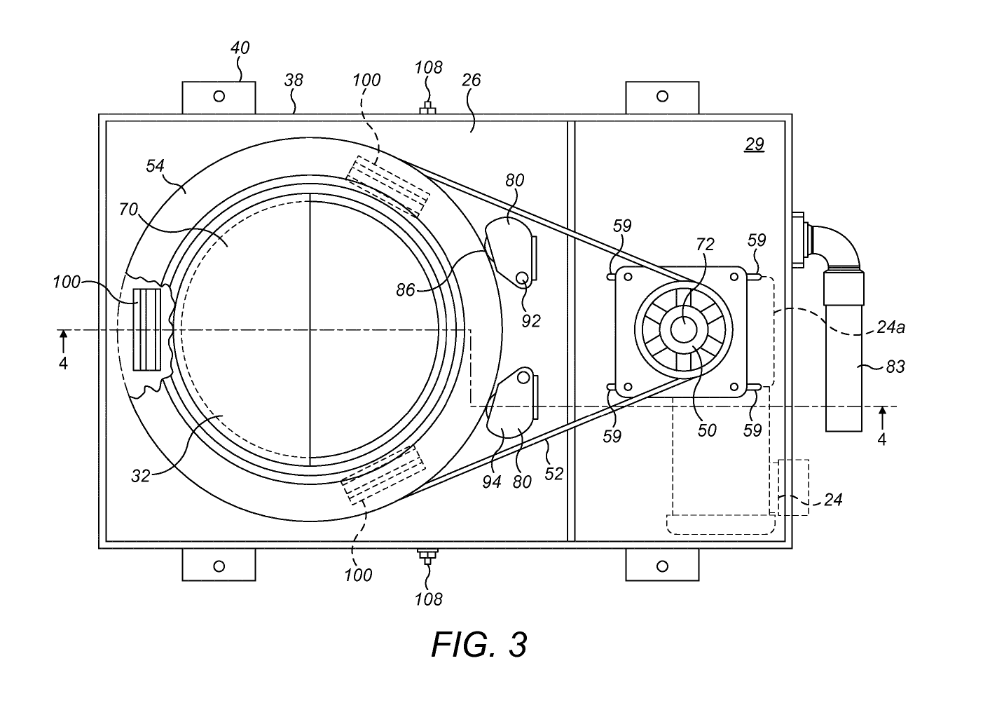

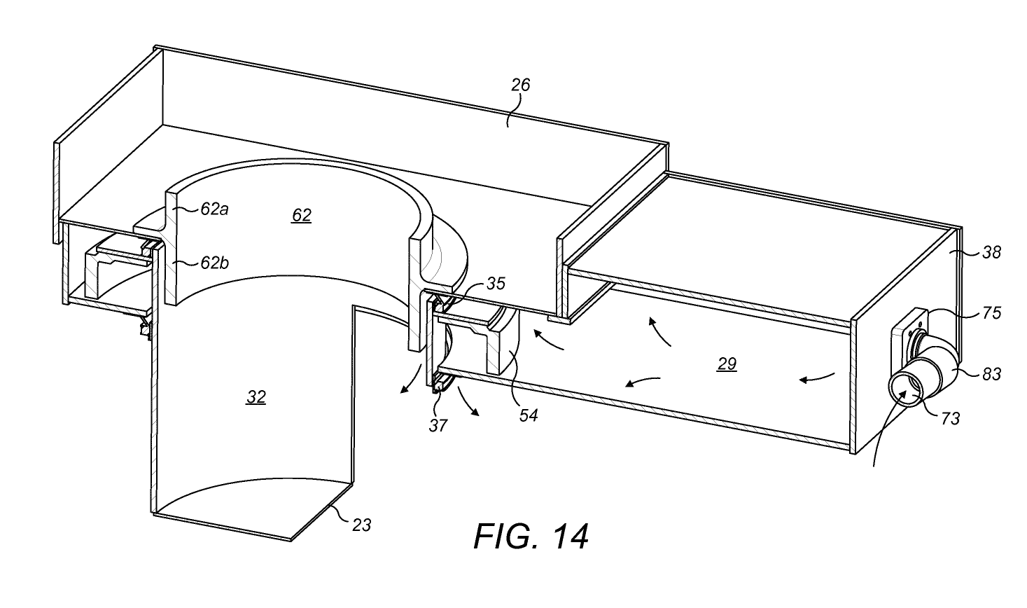

FIG. 3 shows a bottom view of the improved feed distributor 18. The output shaft 72 of gear reducer 24a (shown in phantom) is coupled to one or more drive wheels, sheaves, or pulleys 50, which is connected to one or more drive belts 52. Drive belts 52 are engaged with sheave 50 and with sheave structure 54. An air feed assembly indicated generally by reference 83 is mounted at housing 38 so as to be provided in fluid communication with an internal region of housing 38 referred to herein as a working part zone 29 (that is defined by housing 38 and in which the various drive transmission components 241a, 50, 52, 54, 100 etc., are housed. Further details of the air feed assembly 83 is described with reference to FIG. 14 below.

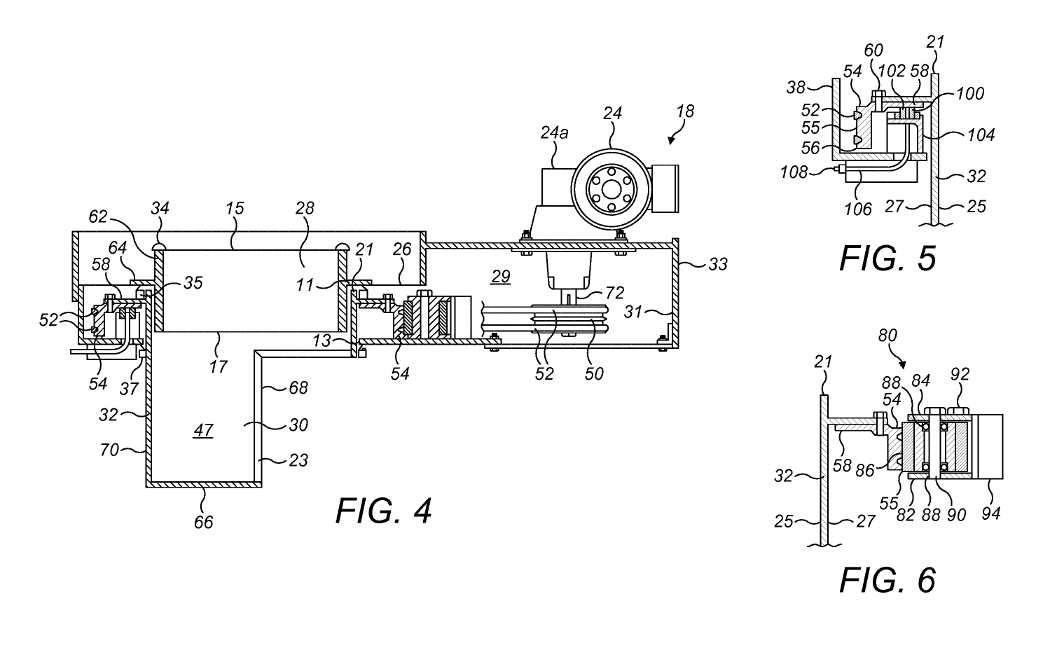

As shown in FIG. 4, the sheave structure 54 is attached to the tubular chute 32. The drive belts 52 are received into belt receiving grooves 56 on the sheave structure 54. The drive belts 52 are preferably V-belts. The drive belts 52 are tightened by adjusting the distance between the sheave 50 and the sheave structure 54. Once the position of the tubular chute 32 is set (as described below) belt tightening is accomplished by means of slotted openings 59 being formed in the mounting for the gear reducer 24a and motor 24 assembly.

As also shown in FIG. 3, the force exerted by the belts 52 about the sheave structure 54 and tubular chute 32 is countered by a pair of idler wheel assemblies 80. Each idler wheel assembly 80 is mounted to the underside of feed platform 26. An idler wheel 86 is rotationally supported by an axle between upper and lower idler brackets. A fastener 92 passes through an offset opening in each of the idler brackets and the feed platform 26 to allow the assemblies 80 to pivot on the feed platform about the axis of the fastener 92. Once the tubular chute 32 is properly positioned within the feed distributor 18, each idler wheel assembly 80 is pivoted such that its idler wheel 86 comes into contact with the face 55 of the sheave structure 54 which is in turn coupled to the tubular chute 32. While not required, a cover 94 may extend about each idler wheel 86 to prevent the build-up of dust and other materials that may adversely affect the performance of the rollers 86 and their bearings 88.

Tubular chute 32 is vertically supported by at least three thrust bearings 100. Each bearing 100 has a bearing surface 102 formed from a composite material commercially known as PEEK. Bearing surfaces 102 support the flange 58 formed on the sheave structure 54 that is coupled to the tubular chute 32.

The platform 26, as shown in FIG. 4, preferably has a square shape, with the inlet 28 and the wear sleeve 62 centered within the platform 26. The height of the platform 26 is shown as being approximately the same height that the wear sleeve 62 extends upwardly from the inlet 28. However, any height that will allow the platform 26 to operate as a rock bed for the feed distributor 18 will suffice.

Further in FIG. 4, the outlet 30 has a base 66, an open side 68, and at least one closed side 70. The open side 68 and the closed side or sides 70 extend laterally upward from the base 66. Preferably, the closed side 70 has a curvilinear shape (see FIGS. 2 and 3), which prevents rocks from unnecessarily building up in the comers of the outlet 30. However, the outlet 30 may have straight sides 70, forming such other geometric shapes, and still fall within the scope of the invention. The outlet 30 is relatively large, thereby increasing throughput capacity of the distributor 18. Referring further to FIG. 4, the motor 24 and the gear reducer 24a are shown connected to the output shaft 72, which drives the drive wheel or sheave 50. The drive wheel 50 rotates the drive belts 52, which pass around the sheave structure 54 coupled to the tubular chute 32, causing the chute 32 to rotate. As the chute 32 rotates, the wear sleeve 62 preferably remains stationary, which contributes to even wear of the sleeve 62, thereby extending the life of the wear sleeve 62.

FIG. 5 is a cross-sectional view depicting the relationship between the stationary housing 38, rotating tubular chute 32, sheave structure 54 and a thrust bearing 100 in greater detail. As shown, the sheave structure 54 includes two grooves 56 for receiving the drive belts 52 that rotate the chute 32. The drive belts 52 are preferably v-belts. Sheave structure 54 also includes a horizontal flange portion 58. The sheave structure 54 is coupled to the chute 32 utilizing fasteners 60 as shown. The flange portion 58 has a smooth underside surface that is supported on thrust bearings 100 at bearing surfaces 102. Each thrust bearing 100 is supported on a bearing block or support 104. The bearing blocks 104 are affixed to housing 38. A lubricant line 106 supplies a lubricant, such as grease to the thrust bearing surface 102. Fittings, such as grease fittings 108 are mounted outside the housing 38 so that the thrust bearings 100 can be periodically lubricated without having to remove any components from the feed distributor 18.

While it has been found that the presence of lubricant reduces an audible hum from the feed distributor during operation, it is not necessary to supply lubricant to any of the thrust bearings 100 during operation of the feed distributor 18. In other words, the performance of the feed distributor remains the same with or without the presence of lubricant at the interface of the flange portion 58 and thrust bearing surface 102.

Housing 38 comprises a first mouth or aperture 11 provided at the region of platform or feedbox 26. Aperture 11 is generally circular and comprises a diameter being larger than an external diameter of sleeve 62 such that sleeve 62, having a generally cylindrical configuration, is capable of extending through aperture 11 and into a part of the working part zone 29 defined by housing 38. Sleeve 62 comprises an inlet 15 and an outlet 17 such that feed material is capable of flowing into the generally cylindrical sleeve 62 through inlet 15 and to exit via outlet 17. Sleeve 16 is mounted at feedbox 26 so as to have a degree of lateral play (in a radial direction relative to a central axis 79 of sleeve 62 and rotatable chute 32). Housing 38 also comprises a second mouth or aperture 13 positioned generally vertically below first aperture 11 and is generally co-aligned with first aperture 11 to be centered on axis 79. Second aperture 13 is generally circular and provides a means of receiving and mounting rotatable chute 32 at the feed distributor. In particular, an uppermost axial end of chute 32 is received and extends beyond second aperture 13 so as to sit within a part of the working part zone 29. As will be appreciated, a small radial gap is provided between an external facing surface 24 of chute 32 and aperture 13 so as to allow chute 32 to rotate relative to housing 38. Chute 32 comprises a corresponding inlet 21 mounted within working part zone 29 (and immediately under feedbox 26) and a corresponding outlet 23 that corresponds to the feed distributor outlet 30. Accordingly, feed material is capable of flowing through sleeve 62 and into a bore 47 defined by an internal facing surface of rotatable chute 32 and then to exit from the feed distributor via chute outlet 23.

So as to prevent ingress of dust and particulate matter into working part zone 29, feed distributor 18 comprises a first seal ring 35 and a second seal ring 37 positioned respectively between a region of chute 32 and respective regions or parts of housing 38 Within this specification, reference to the housing 38 encompasses the feedbox 26 and its surfaces and components. In particular, each of the first and second seal rings 35, 37 is rotatably coupled to chute 32 and are respectively secured against an external facing surface of chute 32 at an axial upper half of chute 32 closest to chute inlet 21.

FIG. 6 is an enlarged cross-sectional view of the relationship between idler wheel assembly 80 and the sheave structure 54. Each idler wheel assembly 80 is mounted to the underside of feed platform 26 (see also FIG. 3). Each assembly 80 includes a lower idler bracket 82, an upper idler bracket 84, an idler wheel 86, a pair of ball bearing assemblies 88, an axle 90 and a fastener 92. The idler wheel 86 is rotationally supported by the axle 90 between the upper and lower idler brackets 84, 82. The fastener 92 passes through an offset opening in the idler bracket 82 and is fastened to the idler bracket 84 through a threaded hole to allow the assemblies 80 to pivot on the base platform about the axis of the fastener 92. Once the tubular chute 32 is properly positioned with respect to the stationary tube 64 and within the feed distributor 18, each idler wheel assembly 80 is pivoted such that its idler wheel 86 comes into contact with the face 55 of the sheave structure 64 coupled to the tubular chute 32. While not required, a cover 94 may extend about each idler wheel 86.

As further shown in FIG. 6, idler wheel 86 makes contact with the vertical face 55 of sheave structure 54 to maintain the predetermined distance between sheave 50 and rotating chute 32 so that the chute is properly centered in the housing 38 and proper tension is maintained by the drive belts 52. It can also be seen that the face 55 of sheave structure 54 is substantially orthogonal to the flange 58 of sheave structure 54.

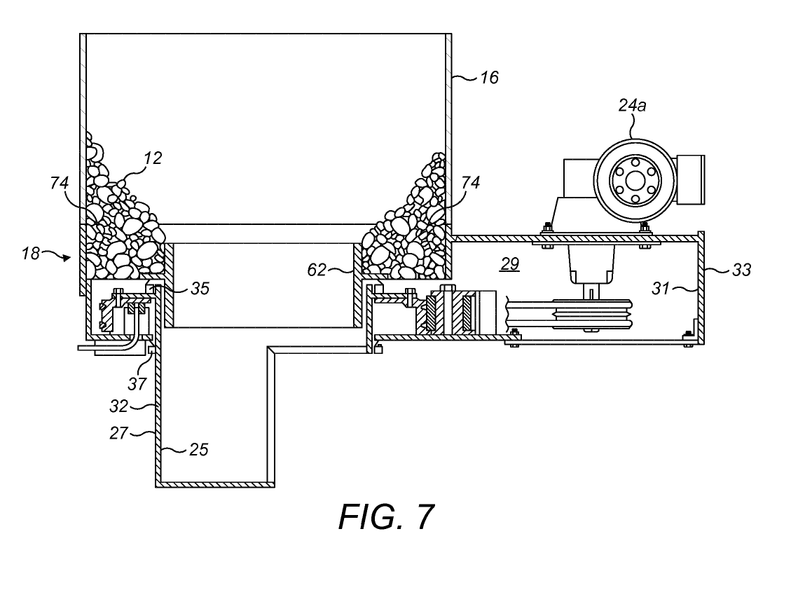

FIG. 7 shows a side view of the feed distributor 18 after rocks 12 have been fed into the feedbox 16. As previously shown in FIG. 1, the feedbox 16 is located directly over the platform 26. The feedbox 16 securely fits onto the platform 26 in a way that will contribute to the platform 26 acting as an accumulator or ‘dead bed’ 74 for the feed distributor 18. The dead bed 74 decreases wear on the feed distributor 18, the chute 32, and the wear sleeve 62. Because the rocks 12 build-up on the platform 26 as opposed to constantly falling down upon the chute 32 and the wear sleeve 62, the wear will be reduced, as there is rock on rock sliding, as opposed to rock on distributor sliding.

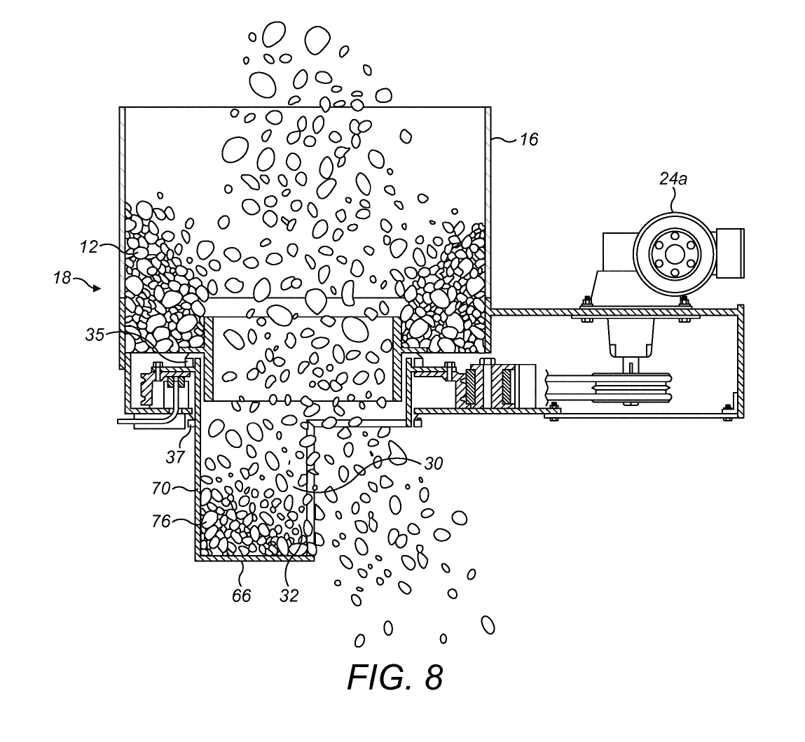

FIG. 8 shows the distributor 18 of FIG. 7 after more rocks 12 have been fed into the distributor 18. A second dead bed 76 is formed in the outlet 30, defined by the base 66 and the closed side 70. The second dead bed 76 further reduces wear on the chute 32 and the base 66. Furthermore, the sloped shape of the dead bed 76 allows the rocks 12 to easily exit the outlet 30 without unnecessary wear on the chute 32. However, the rotation of the chute 32 still provides that the rocks 12 are evenly distributed.

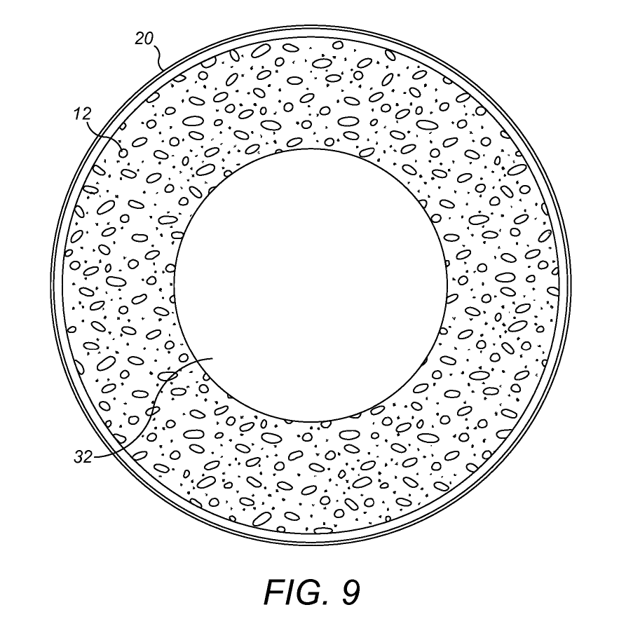

FIG. 9 shows an overhead view of the crusher 20 and the chute 32. Because of the arrangement of the present design, the rocks 12 are evenly distributed throughout the crusher 20. Because the rocks 12 are fed into the crusher 20 with less size segregation and more uniformity, the crusher 20 will more efficiently crush the rocks 12. Likewise, it is advantageous that the chute 32 is centered over the crusher 20 for further uniformity of the fed rocks 12.

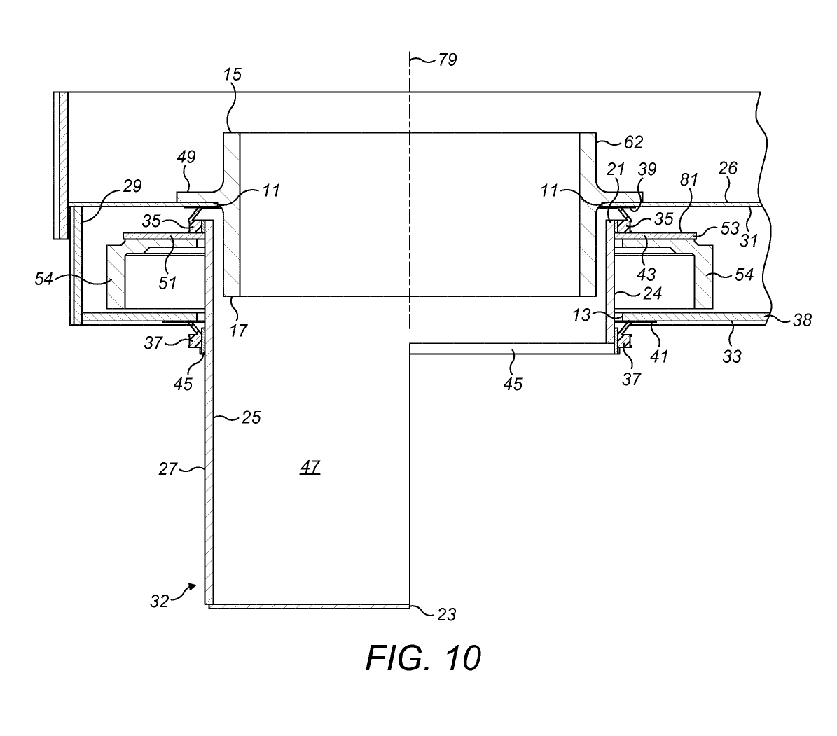

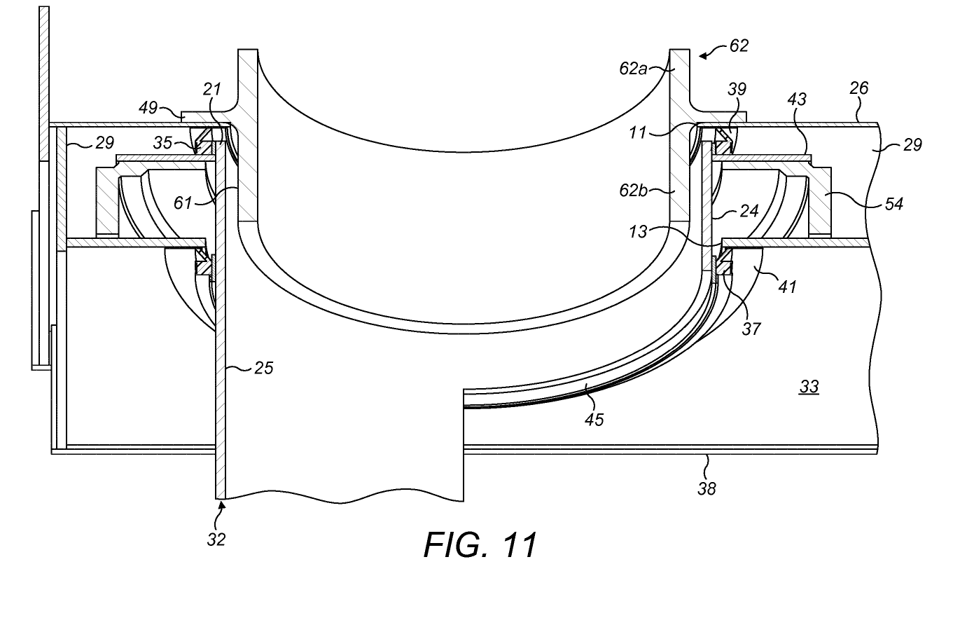

Referring to FIGS. 10 and 11, according to the specific implementation, sleeve 62 comprises a first upper cylindrical portion 62a and a second lower cylindrical portion 62b with portions 62a, 62b separated by a radially outward projecting annular flange 49 configured to abut against a lower or base region of feedbox 26. The uppermost region of chute 32 (at the region of chute inlet 21) is positioned concentrically with and surrounds the sleeve axially lower portion 62b. Accordingly, an external facing surface 61 of sleeve portion 62b is positioned opposed to an internal facing surface 25 of chute 32 that define internal bore 47. Accordingly, sleeve outlet 17 extends into chute bore 47 beyond chute inlet 21.

Chute 32 comprises a radially outward projecting flange 43 extending from an outward facing surface 24 of chute 32 immediately below chute inlet 21. Flange 43 is separated from chute inlet 21 by a short axial distance. Flange 43 comprises a annular downward facing surface 51 configured for positioning against an annular upward facing surface 53 of sheave structure 54. Accordingly, chute 32 is mounted to rest upon sheave 54 and is secured via fasteners 60 as illustrated referring to FIG. 5. First seal ring 35 is mounted to extend around the uppermost end of chute 32 immediately below chute inlet 21. In particular, first seal ring 35 is configured to sit upon an upward facing surface 81 of flange 43 and against chute outward facing surface 27. An upper portion of seal ring 35 is also positioned opposed to a region of an inward facing surface 31 that defines housing working part zone 29. Seal ring 35 is positioned at housing internal facing surface 31 at a region immediately surrounding first aperture 11. A thin plate-like annular gasket 39 is mounted at housing inward facing surface 31 immediately around aperture 11 with first seal ring 35 positioned against gasket 39. Seal ring 35 is secured so as to be rotatably coupled to chute 32 via an annular clamp ring (not shown). Accordingly, seal ring 35 provides an appropriate seal between chute outward facing surface 27 and the housing internal facing surface 31 at the region of first aperture 11. Accordingly, a gap region between chute inlet 21 and the working part zone 29 is sealed by seal ring 35 so as to prevent the ingress of dust and debris into the working part zone from the region of bore 47. In particular, the axial overlap of the sleeve lower portion 62b and the upper region of chute 32 is configured to inhibit larger particulates from passing between the region of the chute inlet 21 and housing 38, with finer entrained particles (dust) being blocked from entering working part zone 29 by the first seal ring 35.

The protection of the working part zone 29 and in particular the internal drive components described with reference to FIGS. 3 to 6 (including in particular bearing 100 and associated bearing surfaces) is enhanced by the provision of the second lower seal ring 37. Second seal ring 37 is a mirror image of first seal ring 35 and is mounted at and in close proximity to second aperture 13 so as to provide a dust seal arrangement at the region between chute external facing surface 27 and second aperture 13. According to the specific implementation, a second annular gasket 45 is mounted to extend around chute external facing surface 27 so as to provide a mount for second seal ring 37 which is similarly clamped onto chute 32 via a clamp ring (not shown). A third annular plate-like gasket 41 is mounted immediately around second aperture 13 at a region of an external facing surface 33 of housing 38. Accordingly, a part of second seal ring 37 is mounted in touching contact against third gasket 41 so as to provide an appropriate seal between the chute external facing surface 27 and second aperture 13.

According to the specific implementation, the first and second seal rings 35, 37 are coaxially located at the external facing surface 27 of chute 32 and provide a dual sealing arrangement to prevent the ingress of dust into the working part zone 29 at two separate regions of housing 38 corresponding to the first and second apertures 11, 13. As will be appreciated, the first seal ring 35 is configured to prevent the ingress of dust or particulates flowing between the sleeve inlet 15 to chute outlet 23 whilst the second seal ring 37 is configured to prevent the ingress of dust into working part zone 29 resulting from the general dust laden environment immediately above the crusher and surrounding the feet distributor 18. As the chute 32 extends from an external region of the housing 38 (and the working part zone 29) and into the housing 38 (and the working part zone 29), the present seal rings 35, 37 are positioned to seal against both the external and internal facing surfaces 33, 31 of the housing to provide a secure seal to prevent dust ingress into the working part zone 29.

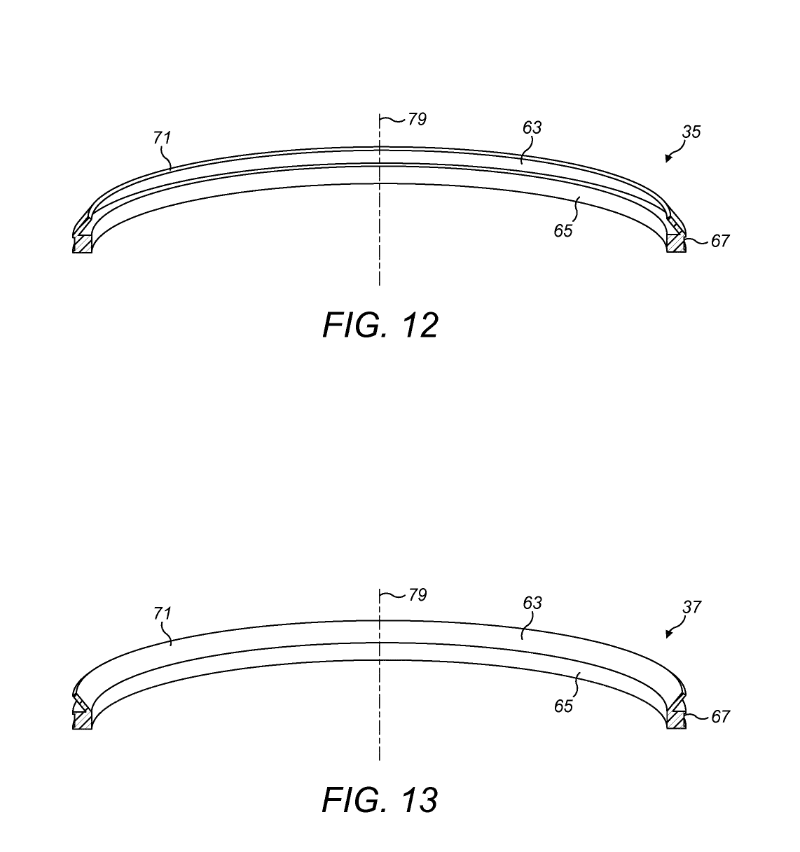

Referring to FIGS. 12 and 13, each of the first and second seal rings 35, 37 comprises a V-ring seal. In particular, each ring 35, 37 comprises an annular main body 65 having a generally square cross sectional profile. A part conical flange 63 projects upwardly from main body 65 and is aligned transverse to central axis 79 about which each ring 35, 37 is centered. In particular, flange 63 of the first upper seal ring 35 is inclined such that an uppermost annular tip 71 of flange 63 is positioned closest to axis 79 relative to a base part of flange 63 positioned at main body 65. Conversely, the corresponding flange 63 of second seal ring 37 is declined such that the annular end tip 71 is positioned radially furthest from central axis 79 relative to a respective base part positioned at main body 65. Each seal ring main body 65 comprises an annular groove 67 formed in an outward facing surface of main body 65 to receive a clamp ring (not shown) so as to secure each ring 35, 37 in position about the chute external facing surface 27. The use of V-ring seals 35, 37 is advantageous in that flexible flanges 63 are configured to be urged against the respective sealing gaskets 39, 41 positioned at the respective regions of housing 38 (in close proximity to the first and second apertures 11, 13). Moreover, the flanges 63 are flexible which is advantageous to reduce wear of the seal rings 35, 37 as they rotate with chute 32 and against the respective gaskets 39, 41. Preferably, the material of each seal ring 35, 37 comprises a polymeric material such as a polyurethane.

Referring to FIG. 14, the present feed distributor 18 is further advantageous to reduce dust ingress into the working part zone 29 by the creation and continuation of a positive pressure within the working part zone 29. Such a configuration is achieved via the air feed assembly 83 mounted at housing 38 and provided in fluid communication with the working part zone 29. According to the specific implementation, air feed assembly 83 comprises ducting 73 mounted at housing external facing surface 33 via a mount boss 75. A fan, compressor or other pneumatic drive (not shown) of conventional design is mounted within or coupled to ducting 73 so as to force a flow of air through ducting 73 and into the working part zone 29 via an aperture (not shown) with a wall of housing 38 (defined between the internal and external facing surfaces 31, 33). The air feed assembly 38 is compatible for use with a feed distributor 18 comprising first and second seal rings 35, 37 and also with a corresponding distributor 18 that does not comprise respective seal rings 35, 37. That is, where the distributor 18 comprises seal rings 35, 37, the positive air pressure created within working part zone 29 may be modest so as to provide a modest ‘back pressure’ against the respective flanges 63 of the seal rings 35, 37. The prevention of dust ingress is accordingly provided by a combination of the positive air pressure and the seal rings 35, 37. Such an embodiment may involve providing a small (1 to 5 mm) gap between the respective flanges 63 and the respective gaskets 39, 41 so as to allow a low to modest exhaust air flow to exit working part zone 29 at the two regions of the housing apertures 11, 13. As will be appreciated, such an exhaust air flow at the region between chute 32 and each respective housing aperture 11, 13 is effective to prevent dust ingress that would otherwise need to flow in the opposite flow direction, against the exhaust air flow. However, the combination of the air feed assembly 83 and seal rings 35, 37 is also compatible with no gap between the respective seal rings 35, 37 and gaskets 39, 41. As will be appreciated, appropriate control units may be coupled to the air flow drive (fan, compressor etc.,) so as to regulate and control the magnitude of the positive pressure within the working part zone 29 and accordingly the flow speed of the exhaust air stream from housing apertures 11, 13.

1. A rotating feed distributor for a crusher comprising:
a housing defining an internal working part zone
a rotatable chute arranged to receive crushable material to be fed to a crusher, the chute defining at least part of an internal bore provided with an inlet and an outlet;
a sheave provided externally at and rotatably coupled with the chute;
a power means and drive transmission mounted within the working part zone, at least part of the drive transmission coupled to the sheave to provide rotation of the chute relative to the housing; and
at least one seal ring provided at the chute to at least partially close a gap region between the chute and a part of the housing and inhibit ingress of dust into the working part zone.

2. The distributor as claimed in claim 1, wherein the housing includes an inlet aperture and an outlet aperture in fluid communication with the working part zone arranged to allow the crushable material to pass through the housing and into the internal bore the chute projecting through at least the outlet aperture and at least partially into the working part zone.

3. The distributor as claimed in claim 2, wherein at least a first seal ring is provided between the inlet of the chute and a part of the housing that defines the inlet aperture.

4. The distributor as claimed in claim 3, wherein the first seal ring is positioned within the working part zone and is positioned against an internal facing surface of the housing that defines the working part zone.

5. The distributor as claimed in claim 2, wherein at least a second seal ring is provided between the chute and a part of the housing that defines the outlet aperture.

6. The distributor as claimed in claim 5, wherein the second seal ring is positioned externally to the working part zone and against an external facing surface of the housing relative to the working part zone.

7. The distributor as claimed in claim 1, comprising a first seal ring provided at a first region of the chute to provide at least partial closure of a first gap region between the first region of the chute and a first part of the housing that is internal facing relative to the working part zone.

8. The distributor as claimed in claim 7, comprising a second seal ring provided at a second region of the chute to provide at least partial closure of a second gap region between the second region of the chute and a second part of the housing that is external facing relative to the working part zone.

9. The distributor as claimed in claim 8, wherein the first seal ring is positioned at or towards the inlet of the chute and the second seal ring is spatially separated from the first seal ring and is positioned between the first seal ring and the outlet of the chute.

10. The distributor as claimed in claim 1, wherein the at least one seal ring includes an annular main body and a flexible annular flange projecting from the main body.

11. The distributor as claimed in claim 1, further comprising at least one clamp arranged to radially compress against the at least one seal ring and secure the at least one seal ring at an external facing surface of the chute such that the seal ring is rotatably coupled to the chute.

12. The distributor as claimed in claim 1, wherein the chute includes a radially outward projecting shoulder arranged to abut the seal ring.

13. The distributor as claimed in claim 1, further comprising an air feed assembly coupled in fluid communication with the working part zone to provide a supply of air into the working part zone.

14. The distributor as claimed in claim 13, wherein the air feed assembly includes ducting and any one of a fan, a compressor or pneumatic system to generate an air flow stream through the ducting and into the working part zone.

15. A gyratory crusher comprising a feed distributor as claimed in claim 1.

16. The distributor as claimed in claim 1, wherein the chute includes a radially inward projecting groove at an outward facing surface of the chute to at least partially receive the seal ring.
